(19) United States
(12) Patent Application Publication
(10) Pub. No.: US 2021/0234417 A1
(43) Pub. Date: Jul. 29, 2021

(54) ROTOR FOR A ROTATING ELECTRICAL MACHINE

(71) Applicant: MOTEURS LEROY-SOMER, Angouleme (FR)

(72) Inventor: Jacques SAINT-MICHEL, Angouleme (FR)

(73) Assignee: MOTEURS LEROY-SOMER, Angouleme (FR)

(21) Appl. No.: 17/050,293

(22) PCT Filed: Apr. 19, 2019
(86) PCT No.: PCT/EP2019/060223

§ 371 Date: Oct. 23, 2020

(30) Foreign Application Priority Data
Apr. 23, 2018 (FR) 1853552

(51) Int. Cl. H02K 1/24; H02K 15/02

(52) U.S. Cl. CPC H02K 1/24; H02K 15/022

(57) ABSTRACT

A rotor for an electrical machine, rotating about an axis of rotation, the rotor including: salient poles forming slots between them, the salient poles each being of an overall shape that is asymmetrical with respect to a radial midplane containing the axis of rotation of the machine, coils, each coil being placed on a corresponding salient pole, in the slots adjacent to this salient pole.

The present invention relates to the field of rotating electrical machines, notably synchronous machines, and more particularly to the rotors of such machines. The invention is more particularly concerned with salient-pole rotors that create between them slots in which coils are housed.

It is known practice to create a salient-pole rotor, in which the salient poles are symmetrical with respect to a radial axis of the pole. The poles may each comprise two symmetrical pole shoes, placed one on each side of the pole toward the free end thereof. The presence of such pole shoes makes winding onto the pole more difficult and makes the insertion of ready-made coils almost impossible.

There is therefore a need to have a rotating electrical machine rotor that allows easy fitting of the coils in the slots, while at the same time providing good electromagnetic performance.

The invention seeks to respond to this need and achieves this, according to one of its aspects, by means of a rotor for an electrical machine, rotating about an axis of rotation X, the rotor comprising:
salient poles forming slots between them, the salient poles each being of an overall shape that is asymmetrical with respect to a radial midplane containing the axis of rotation X of the machine,
coils, each coil being placed on a corresponding salient pole, in the slots adjacent to this salient pole.

What is meant by “asymmetrical” is that the salient pole is not symmetrical with respect to any radial plane containing the axis of rotation of the machine. As a preference, all the salient poles are asymmetrical in overall shape.

The radial plane considered may be a midplane for the corresponding pole. The midplane may pass through the middle of the surface of the pole at the level of the airgap and/or through the middle of the pole at the level of its attachment to the rotor mass.

The convex envelope of each of the poles may have a plane of symmetry when observed in transverse section, perpendicular to the axis of rotation.

What is meant by “convex envelope” is the smallest convex shape in which the pole is inscribed. The convex envelope is the tight closed line that follows the contour of the pole, connecting the convex contours of the poles with one another. The convex envelope is the closed line of minimum length, which is superposed on the convex or rectilinear portions of the perimeter of the pole and follows chords connecting each time two convex or rectilinear portions separated by a concave portion (when viewed from the outside). A convex envelope corresponds to the region that would be delimited by a stretched elastic band supported exclusively by the perimeter of the pole.

The salient pole may extend along a radial axis of the pole, which may be contained in the abovementioned radial plane. What is meant by “radial axis of the pole” is an axis Y of the pole directed radially, namely along a radius of the rotor. In the invention, this does not refer to an axis of symmetry for the pole. This radial axis may intersect the vertex of the pole. It may be a midline.

By virtue of the invention, the core of the salient pole can be wider than a symmetrical pole core, which means that saturation therein is achieved less rapidly. What is meant by “core” is that part of the pole other than the pole shoes.

The rotor according to the invention makes it possible to obtain a machine having an improved cost, compactness and electromagnetic performance.

Each salient pole may comprise a lateral pole shoe, notably on a first lateral face of the salient pole, when the rotor is observed along the axis of rotation X. The lateral pole shoe on the salient pole makes it possible to increase the width of the salient pole toward its free end, so that there is more flux in the poles, and a higher power is thus obtained. It is also possible to minimize the risk of saturation in the salient poles. The lateral pole shoe may be situated toward the free end of the salient pole and of the first lateral face. The lateral pole shoe may be situated at the front of the pole or at the rear of the pole. The front and the rear of a pole are defined with respect to the direction of rotation of the rotor. Each salient pole comprises a front lateral face and a rear lateral face.

Each salient pole may comprise at least one lateral face devoid of pole shoe.

The lateral pole shoe is preferably situated on the rear face, the first lateral face being the rear face of the pole, when the rotor is intended to be included in a rotating electrical machine used as a motor. For a motor, the rotor preferably rotates in the counterclockwise direction. Thus, the circulation of the flux is offset toward the front of the pole. In this case, the first lateral face is the rear lateral face of the salient pole.

The lateral pole shoe is preferably situated on the front face, the first lateral face being the front face of the pole, when the rotor is intended to be included in a rotating electrical machine used as a generator. For a generator, the rotor preferably rotates in the clockwise direction. Thus, the circulation of the flux is offset toward the rear of the pole. In this case, the first lateral face is the front lateral face of the salient pole. Such a configuration offers the advantage of reducing the braking torque when operating in generator mode, something which may prove particularly advantageous in automobile traction.

In instances in which the rotor comprises several salient poles, the lateral pole shoes of the salient poles may all be situated on the same lateral face. For example, the lateral pole shoes of the salient poles of the rotor are all situated on the front lateral face of the corresponding salient pole. In a variant, the lateral pole shoes of the salient poles of the rotor are all situated on the rear lateral face of the corresponding salient pole.

Each salient pole may comprise a second lateral face on the opposite side to the first lateral face, this second lateral face being devoid of a pole shoe. Winding becomes easier, and it is easier to insert coils onto the poles, because of the absence of pole shoe on one side of the salient pole.

In a variant, each salient pole may comprise a second pole shoe, of a shape other than that of the lateral pole shoe situated on the first lateral face of the salient pole. The second pole shoe may be smaller than the first pole shoe. Thus, the salient poles may be wider than if they had comprised two pole shoes of the same size, notably at the level of their core.

The second lateral face may extend in a radial plane Z or a plane making an angle γ with a radial plane passing through its base, notably through the point of intersection of the bottom of the slot adjacent to said salient pole with the second lateral face.

Such a configuration makes it possible to maximize the width of the salient pole at its base, while at the same time allowing the coils to be housed.

The slots are open radially toward the outside and toward the airgap. The rotor is an internal rotor, intended to be housed in an external stator.

The second lateral face may make an angle β with the first lateral face. This angle β may be non-zero. The first and second lateral faces are then not parallel to one another.

The coils may have been inserted over the corresponding salient poles before they are wound. The coils may be prepared separately. In the invention, the rotor is not wound directly onto a tooth. The rotor according to the invention is preferably a rotor with concentrated windings, which means to say that each coil of the rotor extends in two consecutive slots around a single salient pole of the rotor.

A coil, or better still all the coils, may comprise first and second portions housed in two adjacent slots, said first and second portions being situated respectively at distances d1 and d2 from the axis of rotation X. The distances d1 and d2 may be equal or different.

The first portion of a coil is the portion that is placed in a first slot and the second portion is the portion that is placed in a second slot, adjacent to the first.

When the distances d1 and d2 are different, the coil is said to be “deformed”, its first and second portions being connected by a portion of coil which may have an inflection.

In a variant, a coil may comprise first and second portions housed in two adjacent slots, said first and second portions being situated at the same distance d1 from the axis of rotation X. Another coil may comprise first and second portions housed in two adjacent slots, said first and second portions being situated at the same distance d2 from the axis of rotation X. Thus, two different coils, notably two adjacent coils, may comprise first and second portions respectively situated at distances d1 and d2 from the axis of rotation X, which distances are different. In one embodiment, the rotor comprises an alternation of coils of which the first and second portions are situated at the same distance d1 from the axis of rotation X, and of coils of which the first and second portions are situated at the same distance d2 from the axis of rotation X.

A coil, or better still all the coils, may be held on the corresponding salient pole by an adjacent coil and/or by a pole shoe.

In a first embodiment, a coil may be held on the corresponding salient pole by the two adjacent coils.

In a second embodiment, a coil may be held on the corresponding salient pole by two pole shoes of the two adjacent salient poles.

In a third embodiment, a coil may be held on the corresponding salient pole on one side by an adjacent coil and, on the other, by a pole shoe of the corresponding salient pole.

In a fourth embodiment, a coil may be held on the corresponding salient pole on one side by an adjacent coil and, on the other, by a pole shoe of the adjacent salient pole.

What is meant by an “adjacent coil” is the coil placed on the salient pole adjacent to the salient pole corresponding to the coil concerned. The two adjacent coils extend in part into the one same slot. Said slot is formed between the two salient poles bearing the two adjacent coils concerned.

Another subject of the invention, independently of or in combination with the foregoing, is a rotor of an electrical machine, rotating about an axis of rotation X, the rotor comprising:
salient poles forming slots between them, the salient poles each being able to be, for example, of an overall shape that is asymmetrical with respect to a radial plane containing the axis of rotation X of the machine, or better still all the salient poles being able to be asymmetrical in overall shape,
coils, each coil being placed on a corresponding salient pole, in the slots adjacent to said salient pole, in which rotor at least one coil comprises first and second portions housed in two adjacent slots, said first and second portions being situated respectively at distances d1 and d2 from the axis of rotation X, the distances d1 and d2 being different.

In one exemplary embodiment, all the coils of the rotor comprise first and second portions housed in two adjacent slots, said first and second portions being situated respectively at distances d1 and d2 from the axis of rotation X, the distances d1 and d2 being different.

Rotor Mass and Shaft

The rotor may comprise a shaft extending along the axis of rotation, on which a magnetic rotor mass comprising the salient poles is placed.

The shaft may be produced from a magnetic material, this advantageously making it possible to reduce the risk of saturation in the rotor mass and improve the electromagnetic performance of the rotor.

In a variant, the rotor comprises a nonmagnetic shaft on which the rotor mass is placed. The shaft may be produced at least in part from a material on the following nonlimiting list: steel, stainless steel, titanium or any other nonmagnetic material.

The rotor mass may in one embodiment be placed directly on the nonmagnetic shaft, for example without an intermediate rim. In a variant, notably in the case where the shaft is not nonmagnetic, the rotor may comprise a rim surrounding the shaft of the rotor and able to bear against the latter.

The rotor mass extends along the axis of rotation and is placed around the shaft. The shaft may comprise means for transmitting torque to the rotor mass.

The rotor mass may be formed from a stack of magnetic laminations. Each magnetic lamination may be of a single piece. A lamination may comprise a succession of sectors connected by tangential bridges of material.

The poles may be of one piece with the rest of the rotor mass, or attached thereto.

Each rotor lamination is for example cut from a sheet of magnetic steel, for example steel 0.1 to 1.5 mm thick. The laminations may be coated with an electrically insulating lacquer on their opposite faces prior to being assembled within the stack. The insulation may alternatively be obtained by a heat treatment of the laminations.

In a variant, the rotor mass may comprise a plurality of pole pieces assembled on the shaft of the rotor, which in this case is preferably nonmagnetic. Assembly may be performed onto a shaft of the machine using dovetails, or as an alternative by means of tie rods. Each pole piece may comprise a stack of magnetic laminations.

The rotor mass may comprise one or more holes in order to lighten the weight of the rotor, make it possible to balance it, or for assembling the rotor laminations of which it is composed. Holes may allow the passage of tie rods that hold the laminations securely together.

The laminations may be cut out one after another in a tool. They may be stacked and clipped or bonded within the tool, in full packs or subpacks. The laminations may be clipped together. In a variant, the pack of laminations may be stacked and welded outside the tool.

The rotor mass may have an external contour which is circular or multi-lobed, a multi-lobed shape potentially being beneficial for example for reducing torque ripples or current or voltage harmonics.

The rotor may be mounted with or without an overhang in relation to the rolling bearings used to guide the shaft.

The rotor may be produced in several sections aligned in the axial direction, for example at least two sections. Each of the sections may be offset angularly with respect to the adjacent pieces (this being known as “step skew”).

The slots may be straight or helicoidal.

Rotor Coils

The rotor coils are placed in the slots in a concentrated manner. What is meant by “concentrated” is that each coil is wound around a single salient pole of the rotor.

The coils comprise electrical conductors. The electrical conductors may be, in transverse section, circular or flattened or substantially polygonal, notably rectangular, in shape.

When the conductors are circular in transverse section, they may be placed in the slot in a hexagonal stack. When the conductors are flattened in transverse section, they may be placed in the slot in one or more rows, notably in a single row, being adjacent to one another via their long sides, also known as the flat. Optimizing the stacking may allow a greater quantity of electrical conductors to be placed in the slots and, at the same time, may allow the useful surface area of the slot to be reduced, thus making it possible to obtain a rotor of higher power, for the same volume. A coil may contain one or several rows of electrical conductors, for example one, two, three or four rows.

The electrical conductors in the slots may be substantially rectangular in transverse section. As a preference, the electrical conductors may be of flattened transverse section, with a long axis parallel to the face of the tooth. The electrical conductors may thus be wound on-flat.

The electrical conductors of a coil may be wound on-edge or on-flat. What is meant by “edge” is the narrow face of the electrical conductor of the coil, as opposed to the “flat”. A coil that is wound on-edge is a coil of which the electrical conductor, of rectangular transverse section, comprising a direction of elongation, is wound perpendicular to this direction of elongation. The electrical conductor is thus wound about an axis of winding that is preferably parallel to the direction of elongation of its transverse section.

The coils may be placed in a cluster of several coils. In other words, the one same electrical conductor forms several coils joined together.

The coils may be wound singly or in cluster, and then deformed.

The electrical conductors may be placed randomly in the slots or arranged therein. As a preference, the electrical conductors are arranged in the slots. What is meant by “arranged” is that the conductors are not placed loosely in the slots but are placed therein in an orderly manner. They are stacked in the slots non-randomly, for example being placed in rows of aligned electrical conductors. The stack of electrical conductors is, for example, a stack in a hexagonal array in the case of electrical conductors of circular transverse section or a stack in one or several rows in the case of electrical conductors of rectangular transverse section.

The electrical conductors are preferably made of metal, notably copper or aluminum.

The electrical conductors are insulated by a surface coating. They may be enameled. The enamel may a thermosetting enamel. The electrical conductors may be enameled and wrapped. Wrapping consists in surrounding the electrical conductor with an insulating fiberglass tape, in order to afford it mechanical protection, something which may notably prove advantageous in machines of great size.

The coils may have a shape that makes it possible to encourage exchange of heat with a cooling fluid. For example, a coil may have an asymmetrical winding overhang. A coil winding overhang is said to be asymmetrical if it is asymmetrical with respect to at least one of the following, this list being nonlimiting: its length, its angle with respect to the axis of rotation, its shape.

In order to encourage the cooling of the coil, the latter may comprise one or more axial openings.

The inlet and outlet of each coil may be situated one on each side of the coil or both on the same side. The connections are preferably situated in the bottom part of the coils, as close as possible to the shaft, which makes it possible to improve mechanical behavior in rotation. In this case, an even number of layers of conductors in the coil are needed.

Variant: inlet and outlet at top and bottom respectively.

As a preference, the coils are separated from the walls of the slot by insulation, notably by at least one sheet of insulation.

The coils are covered with insulation before they are installed on the rotor mass.

The insulation may be of the Nomex™ type, based on aramid fibers, or triplex, comprising a stack of layers such as, for example, one layer of Nomex™, one layer of Mylar™, followed by one layer of Nomex™. The insulation may or may not be bonded in place.

The coils covered with the insulation can then be impregnated with a resin or a lacquer, particularly before being inserted over the salient poles.

The coils may be impregnated each individually, or the complete rotor may be impregnated.

Impregnation may be performed by dip coating or using VPI (Vacuum Pressure Impregnation).

In an embodiment variant, the ends of the winding overhang may be mechanically laced, for example using a Dacron™ (polyamide) tape.

The coils may be wedged in the slots, in order to block them in position in the pole. For this purpose, use may be made of wedges, for example wedges screwed or clipped into the slots. The wedges may be made of aluminum or of plastic and have different shapes. The wedges may act as heat sinks to improve exchanges of heat with the cooling fluid. The wedges may be created in such a way as to leave channels for the circulation of the cooling fluid. The cooling fluid may be air, water, oil.

Machine and Stator

A further subject of the invention is a rotating electrical machine, comprising a rotor as defined hereinabove. The machine may be used as a motor or as a generator. The machine may be a reluctance machine. It may constitute a synchronous motor or, in a variant, a synchronous generator. In a further variant, it constitutes an asynchronous machine.

The machine comprises a stator. The latter comprises teeth defining slots between them. These slots may be closed toward the airgap.

In one embodiment, the stator may comprise a one-piece yoke bearing the teeth. The slots may be closed, both toward the yoke and toward the airgap.

In an embodiment variant, the stator comprises a toothed ring comprising teeth defining between them slots open radially toward the outside, and a yoke attached to the toothed ring.

The stator may comprise windings placed in a distributed fashion in the slots, notably having electrical conductors arranged in the slots.

What is meant by “distributed” is that at least one of the windings passes through two non-adjacent slots in succession.

What is meant by an “attached yoke” is that the yoke is not produced as one piece with the toothed ring but is attached to the latter during the manufacture of the stator.

It is possible for the electrical conductors to be placed in the slots not loosely but in an ordered manner. They are stacked in the slots non-randomly, being for example placed in rows of aligned electrical conductors. The stack of the electrical conductors is for example a stack in a hexagonal array in the case of electrical conductors of circular transverse section.

The installing of the windings may be easier on the one hand because access to the inside of the slots is easier, these being slots that are more widely open and open toward the outside rather than toward the airgap, and on the other hand because the space available around the toothed ring, for the necessary tooling or even for a winding machine, is much greater than the space available in the bore of the stator. Furthermore, the winding operation is relatively inexpensive, in as much as it can be performed in a similar way to the winding of a rotor of a wound-rotor asynchronous or DC machine.

The toothed ring is formed of the collection of teeth of the stator connected at their base on the side of the airgap. The teeth are connected by tangential bridges.

At least one slot may be closed on the side of the airgap by a tangential bridge connecting together two consecutive teeth of the toothed ring, or better still all the slots may be closed on the side of the airgap, each by a tangential bridge connecting together two consecutive teeth of the toothed ring. The tangential bridge or bridges have constant width. In a variant, the tangential bridge or bridges have widths that decrease then increase.

At least one slot may have mutually parallel radial edges, and better still all the slots may have this.

At least one slot may in transverse section, perpendicular to the axis of rotation, be of a shape chosen from the following list: rectangular, hexagonal, this list being nonlimiting. As a preference, at least one slot in transverse section has a bottom that narrows in the direction of the airgap, notably of hexagonal shape. As a preference, the shape of the slot corresponds to the shape of the stack of electrical conductors placed therein, which may notably be the case when the slot is of hexagonal transverse section. Furthermore, the tangential bridges in this case are of non-constant width, decreasing then increasing linearly. Such a configuration of the tangential bridges makes it possible to minimize the harmonics, obtain more torque by desaturation of the teeth and of the yoke, and improve heat transfer.

At least one tooth, or better still all the teeth, may be of trapezoidal overall shape in transverse section.

The electrical conductors in the slots may in transverse section be circular or polygonal, notably rectangular, in shape, this list being nonlimiting. When the conductors are circular in transverse section, they may be placed in the slot in a hexagonal stack. When the conductors are rectangular in transverse section, they may be placed in the slot in a single row, being adjacent to one another via their long sides. Optimizing the stacking may make it possible to place a greater quantity of electrical conductors in the slots and at the same time make it possible to reduce the useful surface area of the slot, thus making it possible to obtain a stator of greater power, for the same volume.

The toothed ring may be produced by winding into a helix a rectilinear strip of teeth which are connected by tangential bridges, the teeth of the rectilinear strip creating between them slots which have convergent edges, the edges of the slots becoming substantially mutually parallel when the strip is wound on itself to form the toothed ring. In a variant, the strip may be formed of sectors each comprising several teeth, the sectors being connected by bridges of material, these sectors being cut from a rectilinear strip of sheet metal.

The yoke may also be produced in a similar way, either by winding directly into a helix a strip of sheet metal if its width permits this, or by forming suitable slots in said strip of sheet metal at the time of cutting out, so as to facilitate this winding.

The yoke may be attached to the toothed ring after the windings have been installed in the slots.

In an embodiment variant, the stator is a stator with concentrated windings. The stator may comprise teeth and coils placed on the teeth. The stator may thus be wound on teeth, or in other words a stator with non-distributed windings.

The stator teeth may comprise pole shoes. In a variant, the stator teeth are devoid of pole shoes.

The stator may comprise an exterior frame surrounding the yoke.

The stator teeth may be produced with a stack of magnetic laminations, each covered with an insulating lacquer, so as to limit induced-current losses.

The machine may operate at a nominal peripheral speed (tangential velocity measured at the outside diameter of the rotor) which may be greater than or equal to 100 meters per second. Thus, the machine according to the invention allows for operation at high speeds if that is desired.

The rotating electrical machine according to the invention may have an outside diameter for example comprised between 100 and 500 mm, better still between 120 and 400 mm, being for example of the order of 200 mm. The inside diameter is for example less than or equal to 300 mm, notably being comprised between 60 mm and 180 mm.

The power of the machine may be comprised between 1 and 300 kW, being for example of the order of 100 kW, this value being entirely nonlimiting.

The machine may comprise a single internal rotor or, in a variant, a single external rotor, or as a further variant, an internal rotor and an external rotor, these being arranged radially one on each side of the stator and rotationally coupled.

The number of slots per pole and per phase may be an integer or a fractional number.

The number of poles P at the rotor is comprised for example between 4 and 48, being for example 4, 6, 8, 10 or 12, and the number of teeth S at the stator is for example comprised between 6 and 48.

Method of Manufacture

A further subject of the invention, independently or in combination with the foregoing, is a method for manufacturing a rotor as defined above, comprising the following steps:

a) preparing a coil on a core, said coil comprising first and second portions which are intended to be housed in slots of the rotor,

b) inserting a first portion of the coil in a first slot adjacent to the first lateral face of a salient pole, said first lateral face comprising a lateral pole shoe,

c) inserting a second portion of the coil in a second slot adjacent to the second lateral face of said salient pole.

A coil may thus comprise first and second portions housed in two adjacent slots. The first and second portions are inserted in such a way as to be situated respectively at distances d1 and d2 from the axis of rotation X, the distances d1 and d2 being equal or different.

Each coil may be formed of at least one wire of rectangular transverse section wound on itself, notably on-edge or on-flat. The wire is preferably wound contiguously.

In one embodiment, a coil is held on the corresponding salient pole by an adjacent coil and/or by a pole shoe. The first portion of the coil may be held under the pole shoe of the corresponding salient pole bearing the coil or under a second coil inserted subsequently. In a variant, the second portion of the coil may be held under the pole shoe of a salient pole adjacent to the salient pole bearing the coil or under a second coil inserted subsequently.

The coil may be deformed at the time of its insertion. The coil may be deformed in such a way as to obtain a coil comprising first and second portions, intended to be housed in two adjacent slots, which are situated respectively at distances d1 and d2 from the axis of rotation X, the distances d1 and d2 being different. The first and second portions are then connected by a coil portion which may exhibit an inflection.

The coil may be offset at the time of its insertion, notably circumferentially, so as to hold it under a pole shoe. In one embodiment, the coil is offset in order to hold its first portion under the pole shoe of the corresponding salient pole bearing the coil. In another embodiment, the coil is offset to hold its second portion under the pole shoe of a salient pole adjacent to the salient pole bearing the coil.

In one embodiment, the coils are inserted over the salient poles of the rotor individually.

In a variant, they are inserted all at once. Thus, one subject of the invention, independently of or in combination with the foregoing, is a method for manufacturing a rotor, notably as defined hereinabove, comprising the following steps:

i) the first portions of all the coils are inserted all at once into the corresponding slots, then

ii) the second portions of all the coils are inserted all at once into the corresponding slots,

iii) the coils are offset circumferentially, notably so as to hold a coil on the corresponding salient pole by means of an adjacent coil and/or by means of a pole shoe.

### DETAILED DESCRIPTION

The invention may be better understood from reading the following detailed description of nonlimiting exemplary embodiments thereof, and from studying the attached drawing in which:

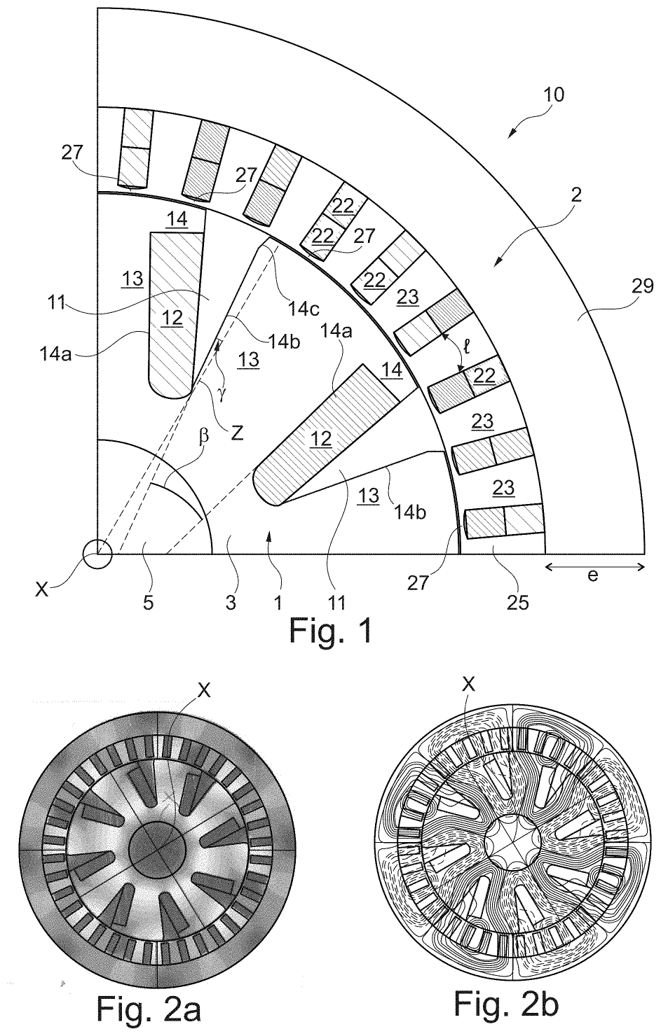

FIG. 1 is a schematic and partial view, in transverse section, of a rotating electrical machine according to the invention,

FIGS. 2a and 2b are views in transverse section of the machine of FIG. 1, respectively showing the induction and the flux lines in the machine,

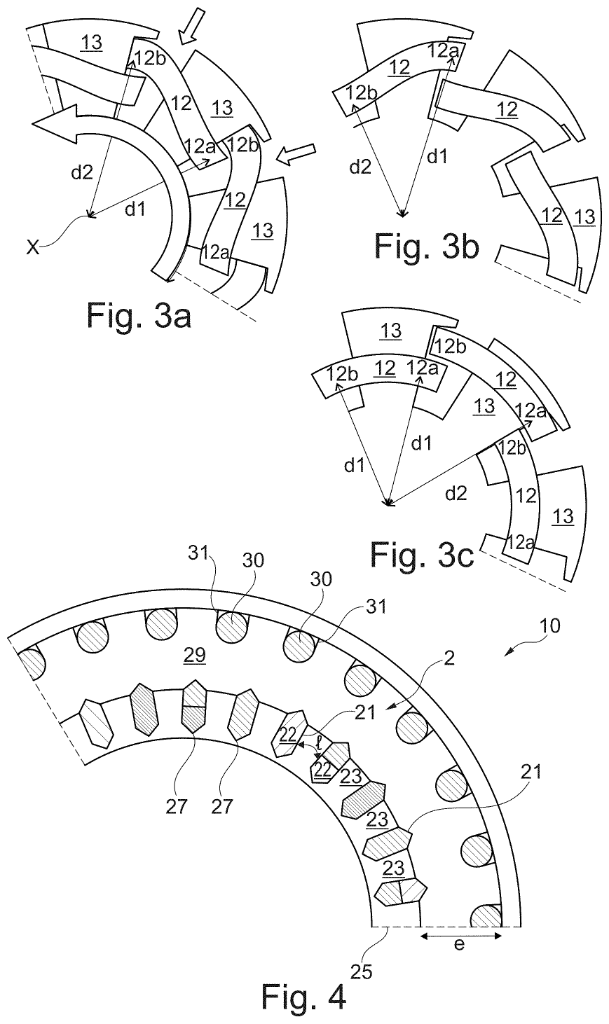

FIGS. 3a to 3c are views similar to FIG. 1 of variant positionings of the coils on the salient poles,

FIG. 4 is a view similar to FIG. 1 of a variant embodiment of a stator,

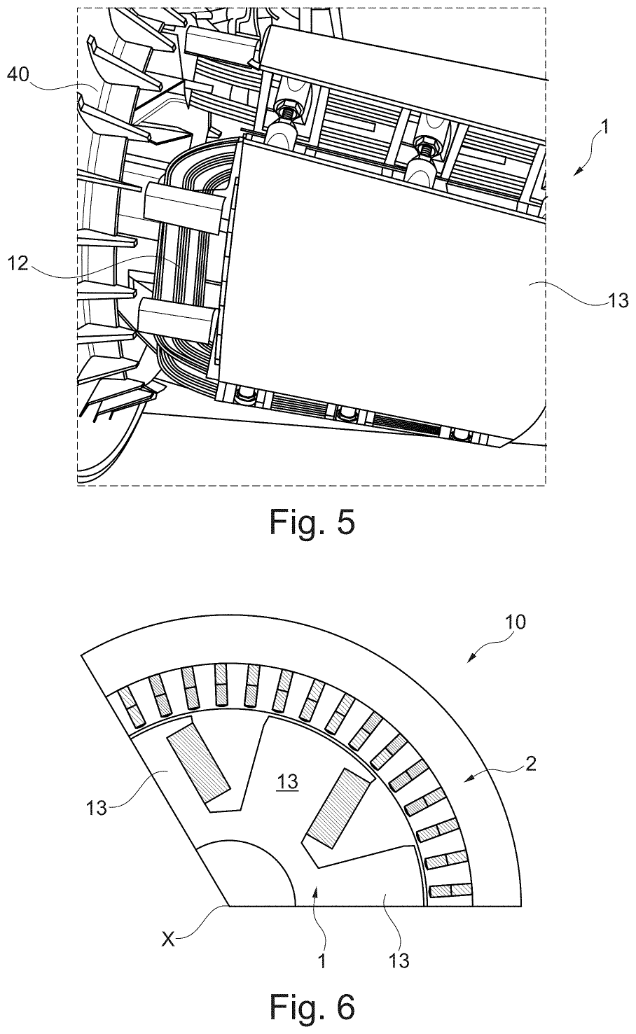

FIG. 5 is a schematic and partial perspective view of a variant machine, and

FIG. 6 is a view similar to FIG. 1 of an embodiment variant.

FIG. 1 illustrates a rotating electrical machine 10 comprising an internal rotor 1 and an external stator 2. The stator makes it possible to generate a rotary magnetic field driving the rotation of the rotor 1, in the context of a synchronous motor, and, in the case of an alternator, the rotation of the rotor induces an electromotive force in the stator windings.

The stator 2 comprises windings 22, as illustrated, which are placed in slots 21 formed between teeth 23 of a toothed ring 25. Furthermore, the stator comprises a yoke 29 attached to the toothed ring 25. The stator further comprises an external frame, not depicted, surrounding the yoke.

The windings 22 are placed in a distributed manner in the slots 21 and have electrical conductors arranged in the slots 21.

The slots 21 in the example described have mutually parallel radial edges and in transverse section are rectangular in overall shape.

The slots 21 are closed toward the airgap by tangential bridges 27 joining together two consecutive teeth of the toothed ring 25. The tangential bridges 27 are of a width which is non-constant, decreasing and then increasing.

The toothed ring 25 is produced by winding into a helix a strip of teeth which are connected by tangential bridges 27. The teeth 23 of the strip create between them the slots 21 which have convergent edges, the edges of the slots being mutually parallel when the strip is wound on itself to form the toothed ring.

Each slot 21 comprises two stacked windings, and therefore two winding stages.

The thickness e of the yoke may be relatively great, in comparison with known machines. The same is true of the width l of the teeth. In this way it is possible to obtain a significant reduction in the consumption of electrical field (or ampere-turns) at the stator, or else a significant increase in the flux passing through the stator.

The rotor 1 depicted in FIG. 1 comprises a magnetic rotor mass 3 extending axially along the axis of rotation X of the rotor, this rotor mass being for example formed by a pack of magnetic laminations stacked along the axis X, the laminations being, for example, identical and exactly superposed. They may be held together by clipping, by rivets, by tie rods, by welding or by any other technique. The magnetic laminations are preferably made of magnetic steel. All grades of magnetic steel can be used.

The rotor mass 3 comprises a central opening for mounting on a shaft 5. The shaft may, in the example considered, be made of a nonmagnetic material, for example of nonmagnetic stainless steel or of aluminum, or on the other hand may be magnetic.

According to the invention, the rotor 1 comprises salient poles 13 creating between them slots 11. The rotor 1 further comprises coils 12, each coil being placed on a corresponding salient pole 13, in the slots 11 adjacent to said salient pole.

The salient poles 13 have an overall shape that is asymmetrical with respect to a radial midplane containing the axis of rotation X of the machine. The salient poles 13 each comprise a lateral pole shoe 14, situated on a first lateral face 14a of the salient pole, when the rotor is observed along the axis of rotation X, toward the free end of the salient pole. In the example described, the lateral pole shoe is situated on the rear lateral face of the salient pole. The salient poles comprise a second lateral face 14b on the opposite side to the first lateral face 14a, which is devoid of pole shoe and may at its end have a chamfer 14c facilitating the insertion of the coils.

The circulation of the flux in this example is offset toward the front in the direction of rotation of the rotor, as illustrated in FIGS. 2a and 2b. Saturation in the salient pole is reached less rapidly.

The second lateral face 14b extends in a plane that makes an γ with a radial plane Z.

The second lateral face 14b makes an angle β with the first lateral face 14a. This angle β is non-zero. The first and second lateral faces are not parallel to one another.

The positioning of the coils in the slots 11 will now be described with reference to FIGS. 3a to 3c.

Each coil 12 comprises first 12a and second 12b portions housed respectively in two adjacent slots 11.

These first and second portions 12a and 12b may be situated respectively at distances d1 and d2 from the axis of rotation X which are different, as illustrated in FIGS. 3a and 3b. When the distances d1 and d2 are different, the coil is deformed, its first and second portions being connected by a curved coil portion. In the example of FIG. 3a, the coil is held on the corresponding salient pole on one side by an adjacent coil and, on the other, by a pole shoe 14 of the adjacent salient pole. In the example of FIG. 3b, the coil is held on the corresponding salient pole on one side by an adjacent coil and, on the other, by a pole shoe 14 of the corresponding salient pole.

In a variant, the coil comprises first and second portions housed in two adjacent slots, said first and second portions being situated at the same distance d1 from the axis of rotation X. This coil is held on the corresponding salient pole by the two adjacent coils.

Another coil comprises first and second portions housed in two adjacent slots, said first and second portions being situated at the same distance d2 from the axis of rotation X. This coil is held on the corresponding salient pole by two pole shoes of the two adjacent salient poles.

Thus, the rotor comprises an alternation of coils of which the first and second portions are situated at the same distance d1 from the axis of rotation X, and of coils of which the first and second portions are situated at the same distance d2 from the axis of rotation X.

In this way, all the coils are held on the corresponding salient pole by an adjacent coil and/or by a pole shoe.

In the embodiment variant illustrated in FIG. 4, the stator differs from that of FIG. 1 in terms of the shape of the slots 21 formed between the teeth 23 of the stator. These slots are hexagonal in overall shape, shaped like the point of a diamond. The electrical conductors in these slots are in transverse section circular in shape. The arrangement thereof is a hexagonal arrangement. Furthermore, in this example, the yoke 29 is equipped with semicircular longitudinal ribs 31 intended to house ducts 30 for the circulation of a cooling liquid.

The rotor coils may comprise a plurality of turns. The turns of one coil may be offset, as illustrated in FIG. 5, something which may make it possible to encourage their cooling. Cooling may also be encouraged via the space left in the coils and between the coils, in the slots.

Furthermore, the machine may comprise a fan 40 placed on the shaft at the level of the tips of the coils, in order to encourage their cooling even more.

In the example of FIG. 1, the number of rotor poles is 8. It would not constitute a departure from the scope of the present invention if this number were different. The machine may, for example, comprise 6 salient poles at the rotor, as illustrated in FIG. 6.

The rotor is obtained by means of the method of manufacture which will now be described in detail.

In a preparatory step, the coils are prepared on cores. Each coil comprises first and second portions which are intended to be housed in rotor slots.

The first portion of the coil is then inserted in a first slot adjacent to the first lateral face of a salient pole, this first lateral face comprising the lateral pole shoe.

Finally, the second portion of the coil is inserted in a second slot adjacent to the second lateral face of the salient pole.

In particular, the first portions of all the coils are inserted all at once in the corresponding slots, then the second portions of all the coils are inserted all at once into the corresponding slots.

Finally, the coils are offset circumferentially, notably so as to hold a coil on the corresponding salient pole by means of an adjacent coil and/or by means of a pole shoe.

The assembly obtained can be impregnated before being inserted into the stator prepared elsewhere.

Of course, the invention is not restricted to the exemplary embodiments which have just been described.

The expression “comprising a” is to be understood as being synonymous with “comprising at least a”.

1. An electrical machine comprising a rotor, rotating about an axis of rotation, the rotor comprising:
salient poles forming slots between them, the salient poles each being of an overall shape that is asymmetrical with respect to a radial midplane containing the axis of rotation of the machine,
coils, each coil being placed on a corresponding salient pole, in the slots adjacent to this salient pole,
and a stator comprising teeth defining slots between them.

2. The electrical machine as claimed in claim 1, wherein each salient pole comprises a lateral pole shoe, notably on a first lateral face of the salient pole, when the rotor is observed along the axis of rotation.

3. The electrical machine as claimed in claim 2, the salient pole comprising a second lateral face on the opposite side to the first lateral face, which is devoid of a pole shoe.

4. The electrical machine as claimed in claim 3, the second lateral face extending in a radial plane or making an angle with a radial plane passing through its base.

5. The electrical machine as claimed in claim 3, the second lateral face forming a non-zero angle with the first lateral face.

6. The electrical machine as claimed in claim 1, the coils having been inserted on the corresponding salient poles after they have been wound.

7. The electrical machine as claimed in claim 1, wherein a coil comprises first and second portions housed in two adjacent slots, the first and second portions being situated respectively at distances from the axis of rotation, the distances being equal or different.

8. The electrical machine as claimed in claim 1, wherein a coil is held on the corresponding salient pole by an adjacent coil and/or by a pole shoe.

9. A rotor of an electrical machine, the rotor comprising:
salient poles forming slots between them, the salient poles each being of an overall shape that is asymmetrical with respect to a radial plane containing an axis of rotation of the machine,
coils, each coil being placed on a corresponding salient pole, in the slots adjacent to the salient pole, in which rotor at least one coil comprises first and second portions housed in two adjacent slots, the first and second portions being situated respectively at distances from the axis of rotation, the distances being different.

10. A rotor of an electrical machine, rotating about an axis of rotation, the rotor comprising:
salient poles forming slots between them, the salient poles each being of an overall shape that is asymmetrical with respect to a radial midplane containing the axis of rotation of the machine, each salient pole comprising a lateral pole shoe, when the rotor is observed along the axis of rotation, the salient pole comprising a second lateral face on the opposite side to the first lateral face, which is devoid of a pole shoe,
coils, each coil being placed on a corresponding salient pole, in the slots adjacent to the salient pole.

11. A rotating electrical machine comprising a rotor as claimed in claim 9 and a stator.

12. The electrical machine as claimed in claim 1, the stator comprising
a toothed ring comprising teeth defining between them slots open radially toward the outside, and
a yoke attached to the toothed ring.

13. The machine as claimed in claim 12, the stator comprising windings placed in a distributed fashion in the slots, notably having electrical conductors arranged in the slots.

14. A method for manufacturing a rotor of an electrical machine as claimed in claim 2, or a rotor comprising:
salient poles forming slots between them, the salient poles each being of an overall shape that is asymmetrical with respect to a radial midplane containing the axis of rotation of the machine, each salient pole comprising a lateral pole shoe, when the rotor is observed along the axis of rotation, the salient pole comprising a second lateral face on the opposite side to the first lateral face, which is devoid of a pole shoe,
coils, each coil being placed on a corresponding salient pole, in the slots adjacent to the salient pole, the method comprising the following steps:
a) preparing a coil on a core, the coil comprising first and second portions which are intended to be housed in slots of the rotor,
b) inserting a first portion of the coil in a first slot adjacent to the first lateral face of a salient pole, the first lateral face comprising a lateral pole shoe,
c) inserting a second portion of the coil in a second slot adjacent to the second lateral face of the salient pole.

15. The method as claimed in claim 14, wherein the first portion of the coil is held under the pole shoe of the corresponding salient pole bearing the coil or under a second coil inserted subsequently.

16. The method as claimed in claim 14, wherein the second portion of the coil is held under the pole shoe of a salient pole adjacent to the salient pole bearing the coil or under a second coil inserted subsequently.

17. The method as claimed in claim 14, wherein the coil is deformed at the time of its insertion.

18. The method as claimed in claim 14, wherein the coil is offset at the time of its insertion, notably circumferentially, so as to hold it under a pole shoe.

19. The method as claimed in claim 14, comprising the following steps:
i) the first portions of all the coils are inserted all at once into the corresponding slots, then
ii) the second portions of all the coils are inserted all at once into the corresponding slots,
the coils are offset circumferentially, notably so as to hold a coil on the corresponding salient pole by means of an adjacent coil and/or by means of a pole shoe.
